(19) United States
(12) Patent Application Publication
(10) Pub. No.: US 2026/0299669 A1
(43) Pub. Date: Oct. 1, 2026

(54) AUDIO PROCESSING

(71) Applicant: Cirrus Logic International Semiconductor Ltd., Edinburgh (GB)

(72) Inventor: Adam BRICKMAN, Austin, TX (US)

(73) Assignee: Cirrus Logic International Semiconductor Ltd., Edinburgh (GB)

(21) Appl. No.: 19/089,365

(22) Filed: Mar. 25, 2025

(51) Int. Cl. G06F 1/3234; G06F 3/01; G06F 3/16

(52) U.S. Cl. CPC G06F 1/3278; G06F 3/011; G06F 3/165

(57) ABSTRACT

A system, comprising: main circuitry, comprising: a central processor; memory comprising software instructions which when executed by the central processor cause the central processor to: output a first audio signal comprising ultrasonic content; audio processing circuitry configured to: receive the first audio signal; apply first hardware audio effects to the first audio signal to generate first hardware processed audio signal; output an output audio signal derived from the first hardware processed audio signal to an output audio transducer; and a controller configured to dynamically adjust the first hardware audio effects applied to the first audio signal based on a presence or absence of audible content in the first audio signal.

### TECHNICAL FIELD

The present disclosure relates to systems and methods for ultrasonic sensing.

### BACKGROUND

Human presence detection is emerging as a useful feature for consumer and business personal computers (PC). Several use cases exist for presence detection, such as ensuring systems lock when a user leaves a workstation to bolster security or automatically pausing media when a user walks away from their workstation.

One known method of detecting the presence of a human in the vicinity of a PC is through the use of ultrasound. Ultrasound or ultrasonic content may be regarded as audio which is outside the frequency of human hearing, typically having a frequency greater than 20 kHz. An ultrasonic probe is output through a speaker of the PC, and a response to the ultrasonic probe is received at a microphone of the PC and processed to detect human presence.

Challenges exist when mixing ultrasonic content with audible (e.g. medial) content. For example, if ultrasonic and audible content are mixed, a change in system volume will affect both ultrasonic and audible content which could be detrimental to successful presence detection. In addition, ultrasonic and audible content may require different levels of audio processing which may not be achievable with conventional mixing.

### SUMMARY

Embodiments of the present disclosure aim to address or at least ameliorate one or more of the above issues by providing a system architecture for a PC which manages signal processing capability for handoff between ultrasonic, audible, and mixed ultrasonic and audible content.

An architecture is proposed to incorporate stream-dependent management of hardware, software and/or firmware configuration. Such configuration may comprise switching between comparatively high-and low-power configurations.

Switching between low-and high-power configurations may comprise changing the amount of signal processing applied in an audio signal chain, which in turn may change signal processing path length. A side effect of such transitions can be the introduction of latency shifts in ultrasonic data. The size of the latency shift may be related to the number and/or type of enabled audio processing algorithms or modules. The size of the latency shift may also vary from system to system (or PC to PC). Such latency shifts may cause errors in ultrasonic presence detection, such as false positives or false negatives. Embodiments of the present disclosure provide mechanisms for communicating an expected change in signal processing latency to an ultrasonic processing module or algorithm. In doing so, signal chain latency changes can be taken into account when determining presence or absence of a human using ultrasonics.

Audio streams containing audible and ultrasonic content are often mixed together to form a single combined signal AC for output at a transducer. In situations where a single stream of already-mixed audio is provided, changes in volume or enabling/disabling of audio mute may impact the effectiveness or function of presence detection since the level of any ultrasonic content would also be affected by a change in volume of audible content. To address this issue, embodiments of the present disclosure may implement one or more mechanisms to prevent the volume of ultrasonic content in a final mixed stream from being affected by requests for changes in system volume (i.e. of audible content).

According to an aspect of the disclosure, there is provided a system, comprising: main circuitry, comprising: a central processor; memory comprising software instructions which when executed by the central processor cause the central processor to: output a first audio signal comprising ultrasonic content; audio processing circuitry configured to: receive the first audio signal; apply first hardware audio effects to the first audio signal to generate a first hardware processed audio signal; and output an output audio signal derived from the first hardware processed audio signal to an output audio transducer; and a controller configured to dynamically adjust the first hardware audio effects applied to the first audio signal based on a presence or absence of audible content in the first audio signal.

According to another aspect of the disclosure, there is provided an integrated circuit (IC), comprising: audio processing circuitry configured to: receive a first audio signal comprising ultrasonic content; apply first hardware audio effects to the first audio signal to generate a first hardware processed audio signal; and output an output audio signal derived from the first hardware processed audio signal to an output audio transducer; and a controller configured to dynamically adjust the first hardware audio effects applied to the first audio signal based on a presence or absence of audible content in the first audio signal.

The following features may apply to one or both of the system and IC described above.

The controller may be implemented in software by the main circuitry. The controller may be implemented by the main circuitry or the audio processing circuitry.

The controller may be integrated into the audio processing circuitry. The controller may at least partially be implemented by a software driver executed on the central processor. Additionally, or alternatively, the controller is implemented in hardware.

The controller may be configured to dynamically adjust the first hardware audio effects between a first mode when audible content is present in the first audio signal, and a second mode when audible content is absent from the first audio signal.

The audio processing circuitry may consume less power when operating in the second mode than when operating in the first mode.

To transitioning between the first and second modes one or more of: level dependent power management and auxiliary noise gating may be adjusted.

Transitioning between the first and second modes may comprise enabling or disabling one or more audio processing algorithms executed by the audio processing circuitry.

The controller may be configured to dynamically adjust the first hardware audio effects by: detecting a change in audio stream content of the first audio signal; and updating a stream list of active audio streams in the first audio signal stored in memory of the audio processing circuitry. The first hardware audio effects may be selected in dependence on the stream list.

The central processor may be configured to: generate a first stream comprising the ultrasonic content; selectively generate one or more second streams comprising audible content; and combine the first and second streams to generate the first audio signal.

The central processor may be further configured to label the first stream and the one or more second streams. Each label may indicate a stream type of an associated first or second stream.

Each stream type may be selected from one or more of: media content, movie content, game chat content, speech content, communications content, alerts content, sound effects content, game media content, game effects content, sensor content, audible content, and ultrasonic content.

The controller may be configured to disable system level changes in volume of the first audio signal or the output audio signal.

In which case, volume may be adjusted at an application or audio stream level. For example, an audio streaming driver may be provided, which may be executed by on the central processor, and in response to a system volume adjustment command, the audio streaming driver may be configured to maintain the first stream at a fixed volume; and adjust the volume of the one or more second streams.

Prior to adjustment of the first hardware audio effects the controller may be configured to output a transition signal, the transition signal indicating a change in signal chain latency associated with the adjustment of the first hardware audio effects.

The controller may be configured to derive the signal chain latency using an audio analyzer.

The controller may be configured to calculate the signal chain latency by combining latency data from one or more processing modules in the signal chain.

The signal chain latency may be stored in a configuration file in the memory.

The system may further comprise ultrasonic presence detection circuitry configured to: receive an input audio signal derived from an input audio transducer, the input audio signal comprising a reflected component of the ultrasonic content present in the output audio signal; and determine the presence of a human proximate the system based on the input audio signal and the output audio signal.

The ultrasonic present detection circuitry may be configured to: receive the transition signal; and determine the presence of a human proximate the system based on transition signal.

The first hardware audio effects may comprise one or more of: baseline speaker protection; rattle distortion reduction; distortion limiting; crossover filtering; spatial processing; equalization; virtual and/or dynamic bass enhancement.

The central processor may be configured to apply first software audio effects to generate the first audio signal.

The system may further comprise a communications channel between the main circuitry and the audio processing circuitry.

The system may further comprise the output audio transducer.

The audio processing circuitry may comprise an amplifier configured to amplify the first hardware processed audio signal to obtain the output audio signal.

The first hardware processed audio signal may be a digital signal. The audio processing circuitry may comprise a digital-to-analog converter (DAC) for converting the first hardware processed audio signal to the analog domain.

The audio processing circuitry may comprise an audio CODEC configured to generate the output audio signal.

The audio processing circuitry may comprise a digital signal processor (DSP) configured to apply the hardware audio effects.

The main circuitry may be integrated into a first integrated circuit (IC). The audio processing circuitry may be integrated into a second IC separate from the first IC. The controller may be integrated into the second IC.

The controller may be integrated into a third IC separate from the first and second ICs.

According to another aspect of the disclosure, there is provided an electronic device, comprising a system of IC as described above.

The electronic device may comprise one of a wearable device, an analyte monitoring device, an analyte sensing device, a battery, a battery monitoring device, a mobile computing device, a laptop computer, a tablet computer, a games console, a remote control device, a home automation controller or a domestic appliance, a toy, a robot, an audio player, a video player, or a mobile telephone, and a smartphone.

According to another aspect of the disclosure, there is provided a method of dynamically adjusting first hardware audio effects, the method comprising: receiving a first audio signal comprising ultrasonic content; applying the first hardware audio effects to the first audio signal to generate a first hardware processed audio signal; and outputting an output audio signal derived from the first hardware processed audio signal to an output audio transducer; wherein the first hardware effects are dynamically adjusted in dependence on a presence or absence of audible content in the first audio signal.

Throughout this specification the word “comprises”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the present disclosure will now be described by way of non-limiting examples with reference to the drawings, in which:

FIG. 1 is schematic diagram of a personal computer (PC);

FIG. 2 is a flow diagram illustrating processing of an audio signal by the PC of FIG. 1; and

FIG. 3 is flow diagram of a process for dynamically adjusting audio processing settings which may be implemented by the PC of FIG. 1.

### DESCRIPTION OF EMBODIMENTS

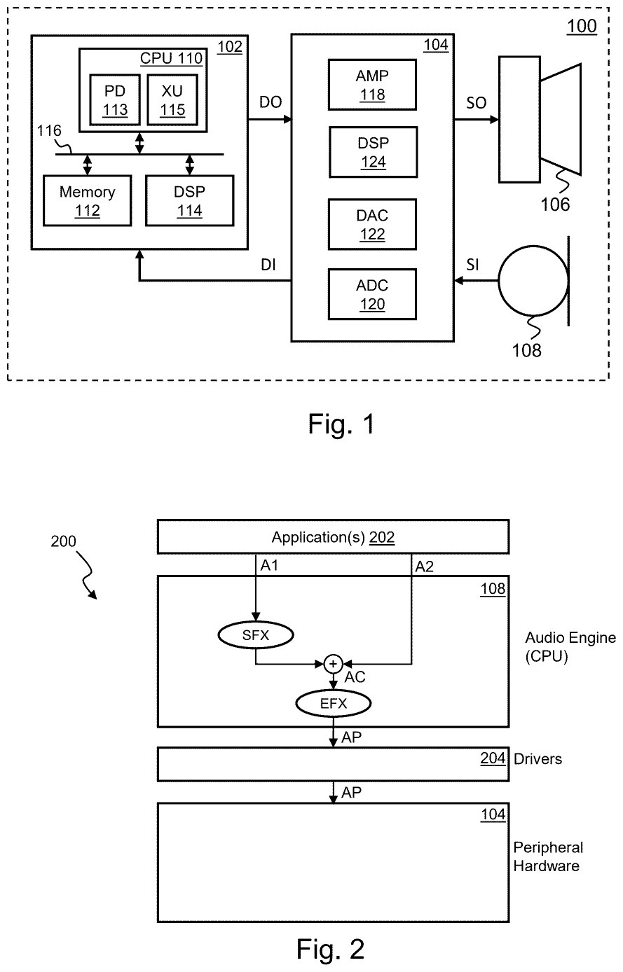

FIG. 1 is a schematic diagram of a personal computer (PC) 100. For clarity of explanation, only components of the PC 100 relevant to the present disclosure are shown. The PC 100 may comprise additional components (not shown), as is known in the art.

The PC 100 comprises main circuitry 102, peripheral audio processing circuitry 104, an output audio transducer 106 (e.g. a speaker), and an input audio transducer 108 (e.g. a microphone).

The main circuitry 102 may be integrated onto a single integrated circuit (IC) or system on chip (SoC). The peripheral audio processing circuitry 104 may be integrated onto a single IC or multiple ICs. The main circuitry 102 may be provided on a separate IC to the one or more ICs integrating the peripheral audio processing circuitry 104.

The main circuitry 102 comprises a central processing unit (CPU) 110, a memory 112, and optionally a digital signal processor (DSP) 114, which may each communicate with one another via a bus 116. The memory 112 may store instructions which, when executed by the CPU 110 may cause the CPU 110 to perform one or more processes, as will be described in more detail below. The CPU 110 may be configured to run one or more audio processing objects (APOs) which may also be stored in the memory 112. Thus, the CPU 110 may be configured to process audio signals received from the audio input transducer 108. The CPU 110 may generate audio signals DO which may be stored in the memory 112 and/or transmitted to the peripheral audio processing circuitry 104. The CPU 110 may also process input audio signals DI received from the peripheral audio processing circuitry 104. The DSP 114 may be integrated on to the same system on chip (SoC) as the CPU 110. The CPU 110 may implement a presence detection (PD) module 113 and an extension unit (XU) 115 as will be discussed in more detail below. In this arrangement, the PD module 113 and the XU driver 115 may be implemented by one or more APOs executed on the CPU. In a variation of the arrangement shown in FIG. 1, the PD module 113 and the XU 115 may be implemented on the DSP 114. Thus, while in the following description reference is made to the PD module 113 and the XU 115 executing on the CPU 110, the present disclosure is not so limited and the PD module 113 and the XU 115 may be implemented on the DSP 114, on the peripheral audio processing circuitry 104, or on a controller (not shown) separate and distinct from the main circuitry 102 and the peripheral audio processing circuitry 104.

As noted above, the main circuitry 102 is configured to communicate with the peripheral audio processing circuitry 104, for example using a communications bus (not shown). The main circuitry may be configured to output one or more audio signals DO to the peripheral audio processing circuitry 104 and receive one or more audio signals DI from the peripheral audio processing circuitry 104.

The peripheral audio processing circuitry 104 may comprise one or more of an amplifier 118, a digital-to-analog converter (DAC) 120, an analog-to-digital converter (ADC) 120, and a DSP 124. For example, where the peripheral audio processing circuitry 104 is configured to process signals for output to the output audio transducer 106, the peripheral audio circuitry 104 may comprise the DAC 120 for converting digital signals, such as the digital audio signals DO output from the main circuitry 102 to the (analog) output signal SO. In addition, or alternatively, the peripheral audio processing circuitry 104 may comprise the amplifier 118 to amplify signals for output to the output audio transducer 106. In another example, where the peripheral audio processing circuitry 104 is configured to process signals from the input audio transducer 108, the peripheral audio processing circuitry 104 may comprise the ADC 120 for converting analog signals from the input audio transducer 108 to digital signals. In another example, where the input audio transducer 108 is a digital microphone outputting digital audio signals, the peripheral audio processing circuitry 104 may not comprise the ADC 120. In another example, the DSP 124 may be provided to process audio signals to be provided to the audio output transducer 106 and/or process audio signals received from the audio input transducer 108. In some embodiments, separate DSPs may be provided for processing of signals proceeding towards the output audio transducer 106 versus those proceeding away from the input audio transducer 108.

The peripheral audio processing circuitry 104 may be provided on a single IC. Alternatively, the peripheral audio circuitry 104 may be provided on multiple ICs. For example, components of the peripheral audio circuitry 104 for processing signals for the output audio transducer 106 may be provided on a separate IC to components of the peripheral audio processing circuitry 104 for processing signals output by the input audio transducer 108.

When provided, the DAC 122 may be configured to convert processed audio signal(s) DO to an analog audio signal SO to be output to the output audio transducer 106. When provided, the amplifier 118 may be configured to amplify the processed audio signal DO for output as the output signal SO. Amplification may be performed in the digital domain (before conversion by the DAC 122) or in the analog domain (after conversion by the DAC 122). The output signal SO may then be then output to the output audio transducer 106 to be played back to the user.

When provided, the ADC 120 may be configured to convert the input signal SI to the digital input signal DI to be output to the main circuitry 102. When provided, the amplifier 118 may be configured to amplify the input signal SI for output as the digital input signal DI. Amplification may be performed in the analog domain (before conversion by the ADC 120) or in the digital domain (after conversion by the ADC 120). The output signal SO may then be then output to the transducer 106 to be played back to a user.

As noted above, embodiments of the present disclosure provide novel techniques for handling the output of ultrasound and audible sound via the output audio transducer 106 of the PC 100. In particular, embodiments of the present disclosure aim to provide a reduction in power consumption associated with audio processing depending on whether audible sound is present in audio streams to be output to the output audio transducer 106.

FIG. 2 is a flow diagram illustrating an example audio processing flow 200 for the PC 100 shown in FIG. 1.

One or more applications 202 running on the main circuitry 102 may each generate an audio stream A1, A2. An audio stream may be initialised by an audio streaming driver. The audio streaming driver may be provided to set up audio streams through the DSP 114. A streaming driver extension may also be provided to expand the streaming capability of the PC 100. The streaming driver extension may indicate to the streaming driver how modules of the DSP 114 are interconnected.

In the example shown, two audio streams A1, A2 are generated. The first audio stream A1 contains audible sound, whilst the second audio stream A2 contains ultrasound. Each of the first and second audio streams A1, A2, may optionally comprise other types of sound. An APO running on the CPU 110 may apply one or more audio effects to one or both of the audio streams A1, A2. In the example shown, audio stream effects (SFX) are applied to the first (audible) audio stream A1, and no effects are applied to the second (ultrasound) audio stream A2. The audio streams A1, A2 may be combined to obtain a combined audio stream AC and one or more audio endpoint effects (EFX) may be applied to the combined audio stream AC to generate a processed audio stream AP. The processed audio stream AP may then be output using one or more software drivers 204 to the peripheral audio processing circuitry 104 for conversion, amplification, and/or additional audio processing (e.g. using the DSP 120).

As noted above, the second audio stream A2 comprises ultrasonic content. Ultrasound (or ultrasonic content) may be provided in the second audio stream A2 for human presence detection. To detect the presence of a human proximate the PC 100, the presence detection module 113 may be configured to cause an ultrasonic probe signal to be output from the audio output transducer 106 periodically, for example every second or half second. The period between probe signals may be configurable. The duration of each probe signal is typically less than 200 ms, for example in the order of 100 ms. Output of the ultrasonic content may be implemented by the DSP 114 of the main circuitry 102 or the DSP 124 of the peripheral audio processing circuitry 104.

Ultrasound incident at the audio input transducer 108 may convert the ultrasound to the input signal SI which is passed to the main circuitry 102 via the peripheral audio processing circuitry 104 for processing by the presence detection module 113 of the main circuitry 102. The CPU 110 or the DSP 114 may run a set of instructions for processing the received digital input signal DI to determine a characteristic of ultrasonic components of the received digital input signal DI. Based on that processing and the second audio stream A2, a determination may be made as to the presence or absence of a human proximate the PC 100. Ultrasonic proximity detection is known in the art and so will not be described in more detail here.

It will be appreciated that audio processing implemented by the peripheral audio processing circuitry 104 for processing audible content (such as media, voice over internet protocol (VOIP) and the like) may not be required for the processing of ultrasonic content. It will also be appreciated that ultrasonic proximity detection requires the periodic output of a ping or probe from the input audio transducer 106, the response to which received at the input audio transducer 108 can be used to confirm whether or not a human is proximate the PC 100. If follows, therefore, that a significant proportion of energy is wasted during periods in which no audible content is present in the combined audio stream AC, that stream undergoing significant over processing by the peripheral audio processing circuitry 104 due to it only containing ultrasonic content. Leaving the peripheral audio processing circuitry 104 enabled at full performance during periods of in which only ultrasonic content is being output can cause excessive power consumption.

To address or at least ameliorate one or more the above issues, stream-dependent management of the peripheral audio processing circuitry 104, firmware and software are proposed to reduce power consumption.

Specifically, a mechanism is provided to dynamically adjust firmware and/or hardware settings based on active streams, such as the first and second streams A1, A2 shown in FIG. 2. Such adjustments may be made, for example, to settings of one or more components of the peripheral audio processing circuitry 104. Such adjustments may be to settings in hardware, software, firmware or a combination of all three. Dynamic adjustment may be implemented at the software driver level. In the example shown in FIG. 1 and described, such adjustments are implemented by the extension unit (XU) 115 implemented on the CPU 110. However, embodiments are not so limited to the XU 115 implementing the dynamic adjustment.

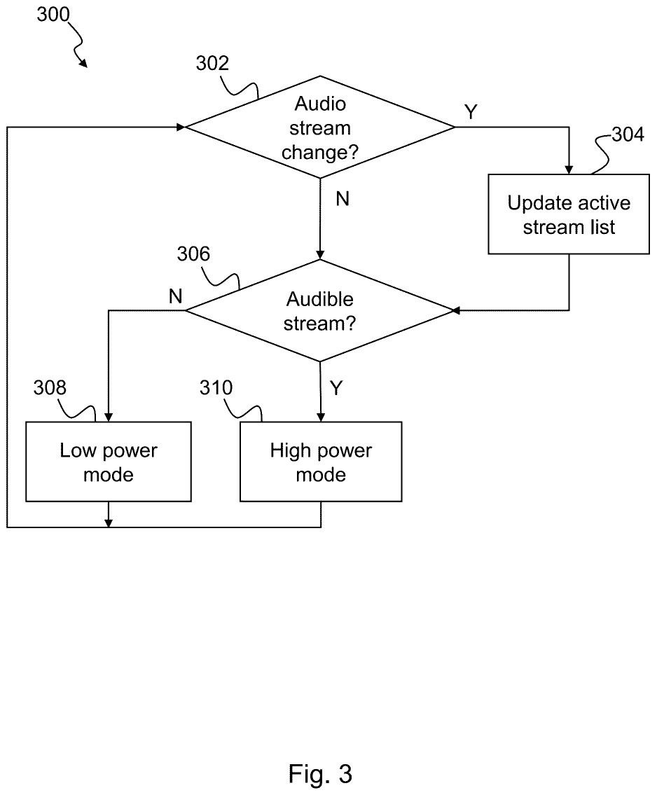

An example implementation of dynamic power adjustment techniques will now be described with reference to FIG. 3.

FIG. 3 is a flow diagram depicting an example process 300 for dynamically adjusting audio processing settings of the peripheral audio processing circuitry 104 which may be implemented by the XU 115.

Each active audio stream (such as the first and second audio streams A1, A2) may be labelled or tagged with a unique identifier including a stream type. A stream type may be defined as comprising a type of audio, such as audible audio, ultrasonic audio or the like. Additionally, or alternatively, a stream type may define the type of audio with a high level of granularity. Examples of stream types include but are not limited to media, movie, game chat, speech, communications, alerts, sound effects, game media, game effects, and sensors (which may include ultrasound). Tagging of active audio streams may be performed by an audio processing object (APO), an audio streaming driver, or another software object stored in the memory 112 and executed by the CPU 110 or DSP 114 on the main circuitry 102.

Based on this information, the XU 115 may configure various settings, registers, and/or processing algorithms in firmware in the peripheral audio processing circuitry 104.

At step 302, a determination is made as to whether a change in audio streams has occurred. Example changes in audio streams include removal (or destruction) of an audio stream, or addition (or creation) of an audio stream. To detect a change in audio streams, on creation or destruction of an audio stream, a signal or message may be sent to the XU 115 of the change. This signal may be generated and output from one or more applications or an APO running on the CPU 110, one or more algorithms being executed on the DSP 114 of the main circuitry 102, or one or more algorithms being executed on the DSP 124 of the peripheral audio processing circuitry 104. When the XU 115 is implemented as a driver, the active stream state(s) and type(s) may be passed to the XU 115 via a class driver whenever a stream is started or stopped. This information may be passed from an operating system to the class driver.

If a change in audio streams is detected, the process 300 proceeds to step 304 at which point a stream list of active streams maintained by the XU 115 is updated. The list may be stored in memory, such as the memory 112 of the main circuitry 102. The process 300 then proceeds to step 306. The list may be maintained in private context data of the XU 115.

Referring again to step 302, if no change in audio streams is detected, the process 300 proceeds to step 306.

At step 306, a determination is made as to whether any of the active audio streams in the stream list contain audible content. If there are no active streams or active streams only contain non-audible (e.g. ultrasonic) content, the process 300 proceeds to step 308 in which the XU 115 controls the peripheral audio processing circuitry 104 to switch to or be maintained in a low-power state. If there are active streams which contain audible content, then the process 300 proceeds to step 310 in which the XU 115 controls the peripheral audio processing circuitry 104 to switch to or be maintained in a high-power state.

To switch between the low-power state and the high-power state, the XU 115 may be configured to configure the peripheral audio processing circuitry 104 to operate with lower power consumption at the detriment of signal processing level and/or quality, or higher power consumption but with a higher level of signal processing level and/or quality. Examples of such configuration changes include adjustment of level dependent power management (LDPM) and auxiliary noise gating (AuxNG). LDPM may be implemented on the peripheral audio processing circuitry 104 which detects idle signal conditions in the amplifier 118 and, under such conditions, configures the amplifier 118 and other circuitry, such as the DAC 122, the ADC 120 and the DSP 124, in a low-power state. So, to reduce power consumption for example, LDPM settings may be set to maximum power savings, including minimal entry-delay and high decibel sensitivity. In another example, auxiliary noise gating may be enabled and set to maximum power savings including minimal entry-delay and high decibel sensitivity. Additionally, or alternatively, one or more algorithms being executed by firmware running on the peripheral audio processing circuitry 104 may be disabled or enabled as appropriate. Examples of such algorithms include algorithms for speaker protection, excursion prevention, resonance distortion prevention, rattle distortion reduction, distortion limiting, crossover filtering, spatial processing, equalisation, and virtual and/or dynamic bass enhancement. It will be appreciated that implementation of many of these audio processing techniques utilises a significant amount of power. Moreover, many of these audio processing techniques are not required when audio comprises only ultrasonic content with no audible component.

To change power state, the XU 115 may be configured to configure one or more settings and/or registers in the peripheral audio processing circuitry 104.

To configure the peripheral audio processing circuitry 104, a command may be sent to software and/or firmware running on the peripheral audio processing circuitry 104 to stop audio processing whilst settings are adjusted. After a successful settings update, a command may be sent to resume audio processing using the new settings.

It will be appreciated that transitions between low-and high-power states may lead to changes in latency of the signal chains between the main circuitry 102 and to and from the input and output audio transducers 106, 108. For instance, when speaker protection is disabled as part of a transition to the low-power state, less signal processing is applied to generate the output signal SO. The resultant output signal SO will therefore appear at the output audio transducer 106 sooner than if speaker protection had been enabled. It will be appreciated that such changes in signal latency will directly affect the accuracy of any presence detection implemented by the presence detection module 113, since ultrasound output from the output audio transducer 106 will arrive sooner or later than expected at the input audio transducer 108 and subsequently the presence detection module 113.

To accommodate for changes in signal latency due to power state transitions, the XU 115 may be configured to transmit information pertaining to power state transitions to the presence detection module 113. For example, in preparation for a transition of the peripheral audio processing circuitry 104 from a low-power mode to a high-power mode or vice versa, the XU 115 may output a transition signal to the PD module 113 indicating a power state transition. Optionally, such an alert may include a value of the impending change in signal latency (e.g. 1 ms). In doing so, the PD module 113 may prepare for an upcoming change in signal latency of one or more audio streams. The total latency value may be specified relative to a full-power path or as an absolute latency.

As noted above, the amount of latency change may depend on the amount of signal processing implemented by the peripheral audio processing module 104. Signal chain latency may be determined in a variety of ways. For example, it may be calculated through live measurements, such as through use of an audio analyzer. In another example, software may be provided that has knowledge of a latency associated with signal processing algorithm enabled and/or disabled during transition between low-and high-power states. A total path latency may be calculated based on this knowledge of latency of individual processing blocks.

The total latency for the peripheral audio processing module 104 may be specified in a configuration file associated with the XU 115. For example, where the XU 115 is implemented as a driver, such information may be provided in an INF file associated with that driver. An INF file may (among other things) define various configurable parameters for the XU 115. In runtime, the configurable latency parameter (stored e.g. in the memory 112) may be fetched and cached by the XU 115. When the XU 115 envisages that a latency shift will occur, via a change to low power settings, the XU 115 may be configured to send a message with this cached latency information to the PD module 113. The PD module 113 may also be implemented as a driver. In which case, communication between the XU 115 and the PD module 113 may be achieved via a private driver-to-driver input/output control (IOCTL) message. For example, the XU 115 may communicate with a driver for the DSP 114 which in turn communicates with a firmware module on the DSP 114 configured to implement one or more processing steps on behalf of the XU 115. The PD module 113 may be implemented as a firmware module implemented on the DSP 114.

Thus, a mechanism is provided to enable transitioning of circuitry such as the peripheral audio processing circuitry between high-and low-power states whilst ensuring any presence detection functionality is maintained.

As noted above with reference to FIG. 2, audio streams containing audible and ultrasonic content are often mixed together to form a single combined signal AC for output to the peripheral audio processing circuitry 104. In situations where a single stream of already-mixed audio is provided, changes in volume or enabling/disabling of audio mute may impact the effectiveness or function of presence detection since the level of any ultrasonic content would also be affected by a change in volume of audible content. To address this issue, the XU 115 may be configured to implement one or more mechanisms to prevent the volume of ultrasonic content in a final mixed stream from being affected by requests for changes in system volume (i.e. of audible content).

For example, the XU 115 may be configured to prevent volume and mute nodes from being created. In doing so, hardware volume settings for the combined stream AC may be fixed for any entity that defines the combined stream AC volume, such that volume control can only be controlled in software by an audio streaming driver, as will now be explained.

As noted above, an audio streaming driver may be provided to initialise audio streams in software, such as the audio streams A1, A2 shown in FIG. 2. The audio streaming driver may process ultrasonic data separately from other data types, such as is the case in FIG. 2. On detection that no downstream circuitry is handling volume control (i.e. the volume of the combined stream AC cannot be adjusted by downstream circuitry), the audio streaming driver assumes responsibility for volume control. Since the audio streaming driver has access to unmixed audio streams that it has initialised, the audio streaming driver has the capacity to control volumes of individual pre-mixed streams. With reference to FIG. 2, for example, the audio streaming driver may be configured to apply volume and/or mute instructions only to the first audio stream A1 comprising audible content whilst maintaining the second audio stream A2 at full volume. This mechanism ensures ultrasonic content in a final mixed audio stream is not affected by requests for changes in system volume or muting.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. A system, comprising:
main circuitry, comprising:
a central processor;
memory comprising software instructions which when executed by the central processor cause the central processor to:
output a first audio signal comprising ultrasonic content;
audio processing circuitry configured to:
receive the first audio signal;
apply first hardware audio effects to the first audio signal to generate a first hardware processed audio signal; and
output an output audio signal derived from the first hardware processed audio signal to an output audio transducer; and
a controller configured to dynamically adjust the first hardware audio effects applied to the first audio signal based on a presence or absence of audible content in the first audio signal.

2. The system of claim 1, wherein the controller is implemented in software by the main circuitry.

3. (canceled)

4. The system of claim 1, wherein the controller is implemented in hardware.

5. (canceled)

6. The system of claim 1, wherein the controller is configured to dynamically adjust the first hardware audio effects between a first mode when audible content is present in the first audio signal, and a second mode when audible content is absent from the first audio signal.

7. The system of claim 6, wherein the audio processing circuitry consumes less power when operating in the second mode than when operating in the first mode.

8. The system of claim 6, wherein transitioning between the first and second modes comprises adjusting one or more of:
level dependent power management; and
auxiliary noise gating, or wherein transitioning between the first and second modes comprises enabling or disabling one or more audio processing algorithms executed by the audio processing circuitry.

9. (canceled)

10. The system of claim 1, wherein the controller is configured to dynamically adjust the first hardware audio effects by:
detecting a change in audio stream content of the first audio signal;
updating a stream list of active audio streams in the first audio signal stored in memory of the audio processing circuitry,
wherein the first hardware audio effects are selected in dependence on the stream list.

11. The system of claim 1, wherein the central processor is configured to:
generate a first stream comprising the ultrasonic content;
selectively generate one or more second streams comprising audible content; and
combine the first and second streams to generate the first audio signal.

12. The system of claim 11, wherein the central processor is further configured to:
label the first stream and the one or more second streams, each label indicating a stream type of an associated first or second stream, wherein each stream type is selected from one or more of: media content, movie content, game chat content, speech content, communications content, alerts content, sound effects content, game media content, game effects content, sensor content, audible content, and ultrasonic content.

13. (canceled)

14. The system of claim 11, wherein the controller is configured to:
disable system level changes in volume of the first audio signal or the output audio signal.

15. (canceled)

16. The system of claim 1, wherein prior to adjustment of the first hardware audio effects the controller is configured to:
output a transition signal, the transition signal indicating a change in signal chain latency associated with the adjustment of the first hardware audio effects.

17. The system of claim 16, wherein the controller is configured to: derive the signal chain latency using an audio analyzer, or calculate the signal chain latency by combining latency data from one or more processing modules in the signal chain.

18.-19. (canceled)

20. The system of claim 16, wherein the system further comprises:
ultrasonic presence detection circuitry configured to:
receive an input audio signal derived from an input audio transducer, the input audio signal comprising a reflected component of the ultrasonic content present in the output audio signal; and
determine the presence of a human proximate the system based on the input audio signal and the output audio signal.

21. The system of claim 20, wherein the ultrasonic present detection circuitry is configured to:
receive the transition signal; and
determine the presence of a human proximate the system based on transition signal.

22. The system of claim 1, wherein the first hardware audio effects comprise one or more of:
a. baseline speaker protection;
b. rattle distortion reduction;
c. distortion limiting;
d. crossover filtering;
e. spatial processing;
f. equalization;
g. virtual and/or dynamic bass enhancement.

23. The system of claim 1, wherein the central processor is configured to apply first software audio effects to generate the first audio signal.

24. (canceled)

25. The system of claim 1, further comprising the output audio transducer.

26. The system of claim 1, wherein the audio processing circuitry comprises one or more of:
a. an amplifier configured to amplify the first hardware processed audio signal to obtain the output audio signal;
b. an audio CODEC configured to generate the output audio signal;
c. a digital signal processor (DSP) configured to apply the hardware audio effects; and
d. a digital signal processor (DSP) configured to apply the hardware audio effects.

27. The system of claim 1, wherein the first hardware processed audio signal is a digital signal, and wherein the audio processing circuitry comprises a digital-to-analog converter (DAC) for converting the first hardware processed audio signal to the analog domain.

28.-29. (canceled)

30. The system of claim 1, wherein the main circuitry is integrated into a first integrated circuit (IC), and wherein the audio processing circuitry is integrated into a second IC separate from the first IC.

31. The system of claim 30, wherein the controller is integrated into the second IC.

32. The system of claim 31, wherein the controller is integrated into a third IC separate from the first and second ICs.

33. An integrated circuit (IC), comprising:
audio processing circuitry configured to:
receive a first audio signal comprising ultrasonic content;
apply first hardware audio effects to the first audio signal to generate a first hardware processed audio signal; and
output an output audio signal derived from the first hardware processed audio signal to an output audio transducer; and
a controller configured to dynamically adjust the first hardware audio effects applied to the first audio signal based on a presence or absence of audible content in the first audio signal.

34. An electronic device, comprising the system of claim 1, wherein the electronic device comprises one of a wearable device, an analyte monitoring device, an analyte sensing device, a battery, a battery monitoring device, a mobile computing device, a laptop computer, a tablet computer, a games console, a remote control device, a home automation controller or a domestic appliance, a toy, a robot, an audio player, a video player, or a mobile telephone, and a smartphone.

35. (canceled)

36. A method of dynamically adjusting first hardware audio effects, the method comprising:
receiving a first audio signal comprising ultrasonic content;
applying the first hardware audio effects to the first audio signal to generate a first hardware processed audio signal; and
outputting an output audio signal derived from the first hardware processed audio signal to an output audio transducer;
wherein the first hardware effects are dynamically adjusted in dependence on a presence or absence of audible content in the first audio signal.
